(19) United States
(12) Patent Application Publication
(10) Pub. No.: US 2024/0211115 A1
(43) Pub. Date: Jun. 27, 2024

(54) Networking Feature for Contact Management Software

(71) Applicant: Fernando Luis Alvarez, Redding, CT (US)

(72) Inventor: Fernando Luis Alvarez, Redding, CT (US)

(21) Appl. No.: 18/397,813

(22) Filed: Dec. 27, 2023

Related U.S. Application Data
(60) Provisional application No. 63/477,246, filed on Dec. 27, 2022.

(51) Int. Cl. G06F 3/0484

(52) U.S. Cl. CPC G06F 3/0484

(57) ABSTRACT

Using an interface and contacts database according to the present technology, a user may add a new contact to their contacts database along with information about how the user met the new contact and/or information about other contacts who are known to or associated with the new contact.

### CROSS-REFERENCE TO RELATED APPLICATIONS

This application is a non-provisional application that claims the benefit of U.S. 63/477,246 filed Dec. 27, 2022.

### TECHNICAL FIELD

This application relates to the contacts feature and user interface that is provided in electronic devices such as mobile phones and computers, for example in phone, chat, e-mail, or social networking clients.

### BACKGROUND

Conventionally, when a user meets a new contact and exchanges contact information, the user opens a contacts interface in a phone, chat, e-mail, or social networking client and adds the new contact's information to the user's contacts database using the contacts interface. There is no provision for associating the new contact with any existing contacts. For example, there is no field in the contacts database nor any control in the user interface to create an ecosystem or grouping of contacts that are associated with or introduced by a particular person or met at a given event or through a given group of people.

### SUMMARY

Using an interface and contacts database according to the present technology, a user may add a new contact to their contacts database along with information about how the user met the new contact and/or information about other contacts who are known to or associated with the new contact.

For example, the technology may be implemented in a device that is configured to display a user interface. The user interface may include a contact card that displays a first contact's name and a first control for accessing a known contacts screen for the first contact; and the known contacts screen for the first contact, which may display at least (i) the name of a contact known by the first contact, and (ii) a second control for adding a new contact name. A contact card for the contact known by the first contact may be accessible from the known contacts screen by actuating the name of the contact known by the first contact. The contact card also may display at least one mode of contacting the first contact.

At least one of the controls may be a button. The device may be a mobile device.

According to aspects of the technology, a device may be configured to implement a contact data structure, which may include a field for the name of a contact; and a field for recording a name of another contact who is known to the contact. The contact data structure also may include a field for recording a mode of contacting the contact.

The device may be a mobile device.

According to aspects of the technology, a method for operating a device may include accessing a contact card in a user interface, wherein the contact card displays an existing contact's name and a first control; and accessing a known contacts screen that is associated with the contact by actuating the first control.

The method also may include accessing a new contact card by actuating a name of a contact on the known contacts screen that is associated with the contact; and entering in the new contact card at least one mode of contacting the contact named on the new contact card.

The device may be a mobile device. The first control may be a button.

In view of the foregoing, techniques of the present invention can provide substantial beneficial technical effects. For example, one or more embodiments provide a contacts database that includes a first contact record with one or more fields for storing information about other contact records that are associated with the first contact record. As another example, one or more embodiments provide a contacts interface that permits a user to input and/or view information about one or more contacts that are associated with a given contact. These advantages may enable a user to have a better understanding of their social connections and relationships and/or where or at what event they met such person(s).

Some embodiments may not have these potential advantages and these potential advantages are not necessarily required of all embodiments. These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a contact card of a user interface (such as the Contacts interface in an Apple or Android phone) that displays information for existing contacts and includes a control (e.g., a red button to the right on the top space of the Contact card) for accessing a known contacts screen.

FIG. 2 depicts the known contacts screen of the user interface that displays the names of one or more contacts known by the existing contact as well as a control for adding a contact to the known contacts screen.

FIG. 3 depicts a contact card of the user interface that displays one or more fields for entering information about a new contact.

FIG. 4 depicts the contact card with completed fields.

FIG. 5 depicts the known contacts screen for the new contact.

FIG. 6 depicts a data structure for recording contact information including known contacts of a contact.

FIG. 7A and FIG. 7B depict a flow diagram of a method for a computing device adding a new contact to the known contacts of an existing contact.

FIG. 8 depicts a flow diagram of a method for a computing device adding an existing contact to the known contacts of a new contact.

FIG. 9 depicts a computing device that is configured to implement the user interface of FIG. 1 through FIG. 5, the data structure of FIG. 6, and the methods of FIG. 7 and FIG. 8.

### DETAILED DESCRIPTION

When meeting a new contact, often the user is introduced to them by an existing contact. The technology disclosed herein provides a way to document the relationship between the user's existing contact and the user's new contact. We are creating a tool to make it easier for people to cluster groups of people they met at certain events or through other people who may have introduced them to a particular person or group. Additionally, through image and content AI, we can eventually download that person's photos and details online onto its contact card. Once we download such technology/plugin through the Google or Apple store, it will provide every contact within your Contacts on Google or Apple or any other Contacts device, a control that you can click on to be able to add contacts that were met through that particular contact to a “circle” in your Contacts. Example: to add more contacts that one meets through someone (i.e. John Doe) in our Contacts, all we need to do is go to (John Doe) click once on the control and add that new person you met through (John Doe).

The present teachings have been described in language more or less specific as to structural, mechanical, and functional features. It is to be understood, however, that the present teachings are not limited to the specific features shown and described, since the apparatus, system, and/or method herein disclosed comprises preferred forms of putting the present teachings into effect.

For purposes of explanation and not limitation, specific details are set forth such as particular structures, architectures, interfaces, techniques, etc. to provide a thorough understanding. In other instances, detailed descriptions of well-known devices and/or methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The use of “first”, “second,” etc. for different features/components of the present disclosure are only intended to distinguish the features/components from other similar features/components and not to impart any order or hierarchy to the features/components, unless explicitly stated otherwise. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C.

Other than in the operating examples, or where otherwise indicated, all numbers expressing quantities of ingredients or reaction conditions used herein are to be understood as modified in all instances by the term “about”.

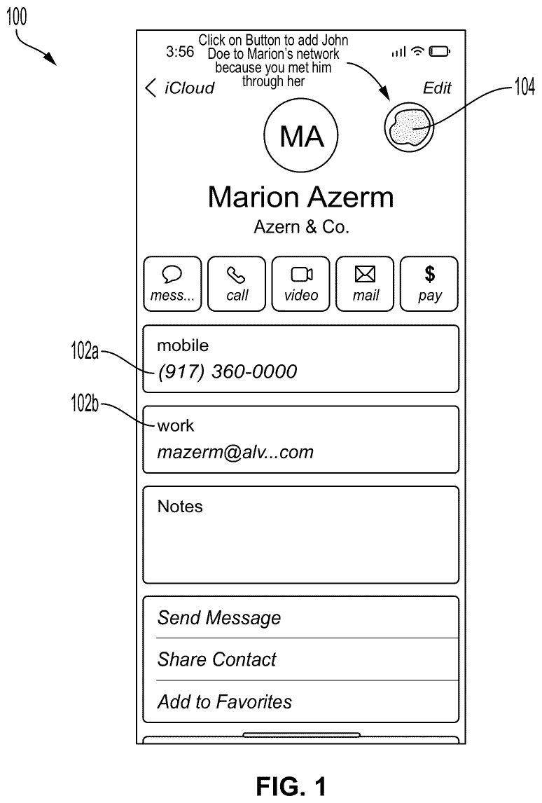

FIG. 1 depicts a contact card 100 of a user interface that displays information 102a, 102b, etc. for an existing contact and includes a control 104 for accessing a known contacts screen that is associated with the contact card 100. In using the technology when the user meet a new contact through an existing contact, the user would first access the contact screen 100 for the existing contact and then actuate the control 104 to access the known contacts screen.

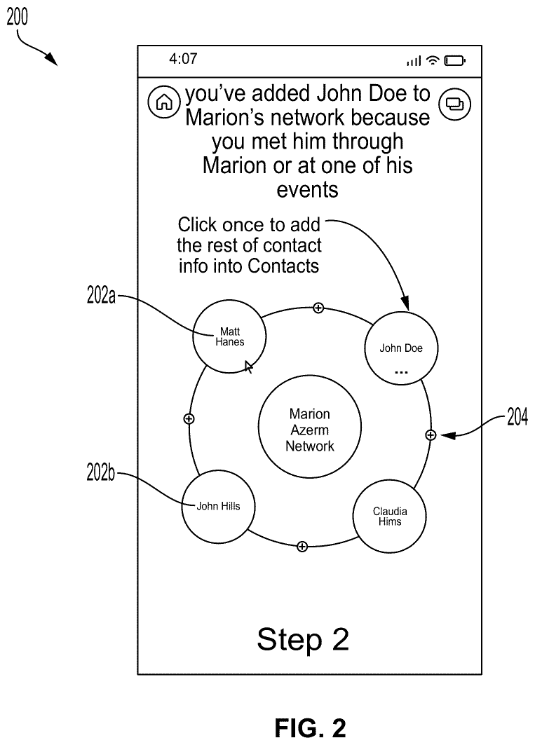

FIG. 2 depicts the known contacts screen 200 of the user interface that displays the names 202a, 202b, etc. of one or more contacts known by the existing contact as well as a control 204 for adding a contact to the known contacts screen. The user can actuate the control 204 to add a contact's name. For example, the user may actuate the control 204 by a tap or click. The user can actuate a contact's name to access a contact card for that contact. For example, the user may actuate the contact's name by a double tap or double click or by a long press.

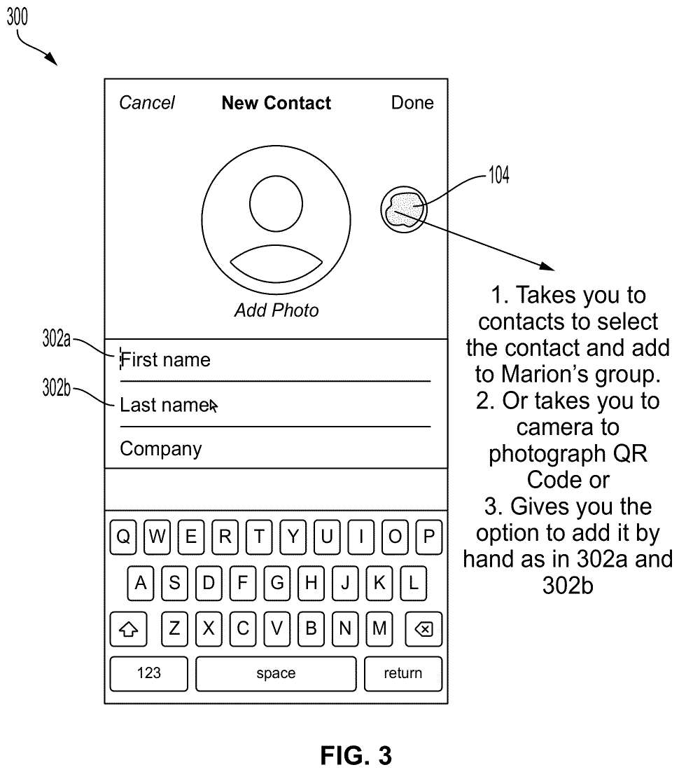

FIG. 3 depicts a contact card 300 of the user interface that displays one or more fields 302a, 302b, etc. for entering information about a new contact. The contact card also includes the control 104 for accessing the known contacts screen 200 that is associated with the contact card 300.

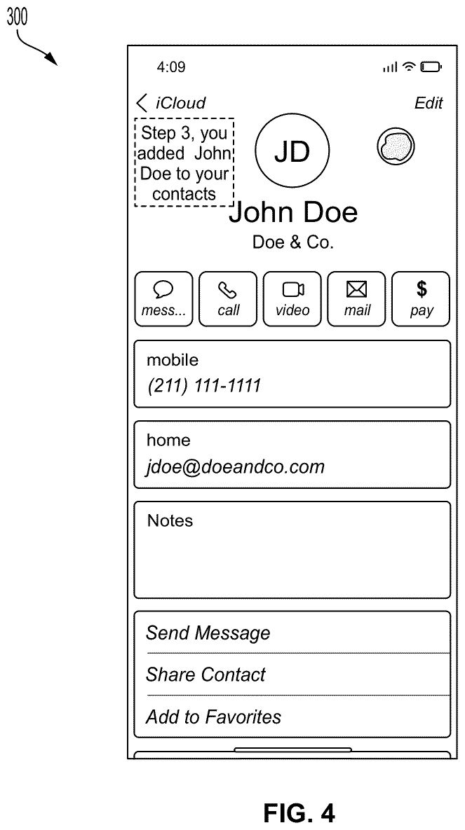

FIG. 4 depicts the contact card 300 with completed fields.

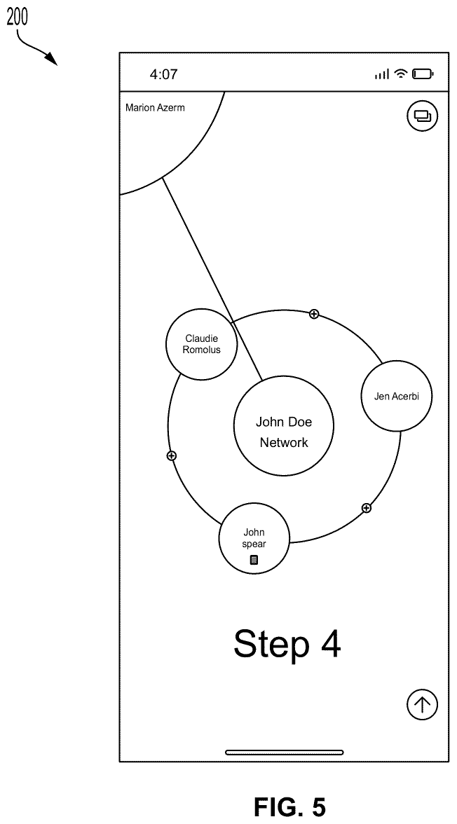

FIG. 5 depicts the known contacts screen 200 that is associated with the contact whose data was entered in the contact card 300.

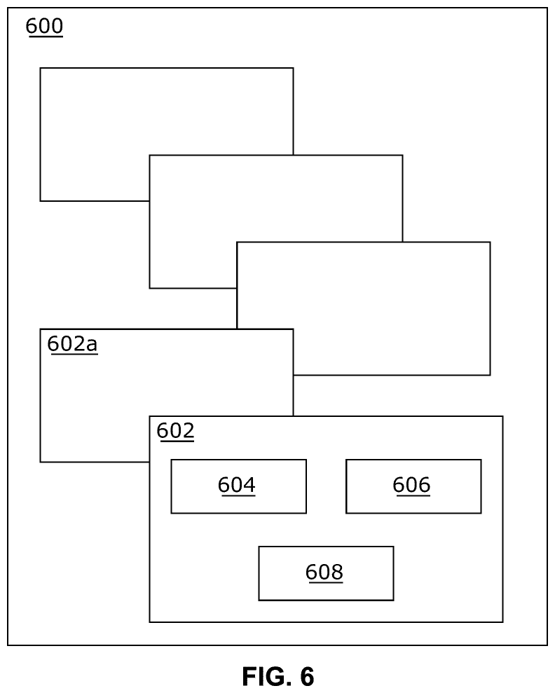

In implementing the technology of FIG. 1 through FIG. 5 in a device, such as a computer or a mobile phone or other mobile device, the device will use a contact data structure. In this regard, FIG. 6 depicts a contacts database 600 that includes one or more data structures 602, 602a, etc. for recording contact information including known contacts of a contact. Each data structure 602 may include at least a field 604 for the name of a contact and a field 606 for recording a name of another contact who is known to the contact. Each data structure 602 also may include at least a field 608 for recording a mode of contacting the contact.

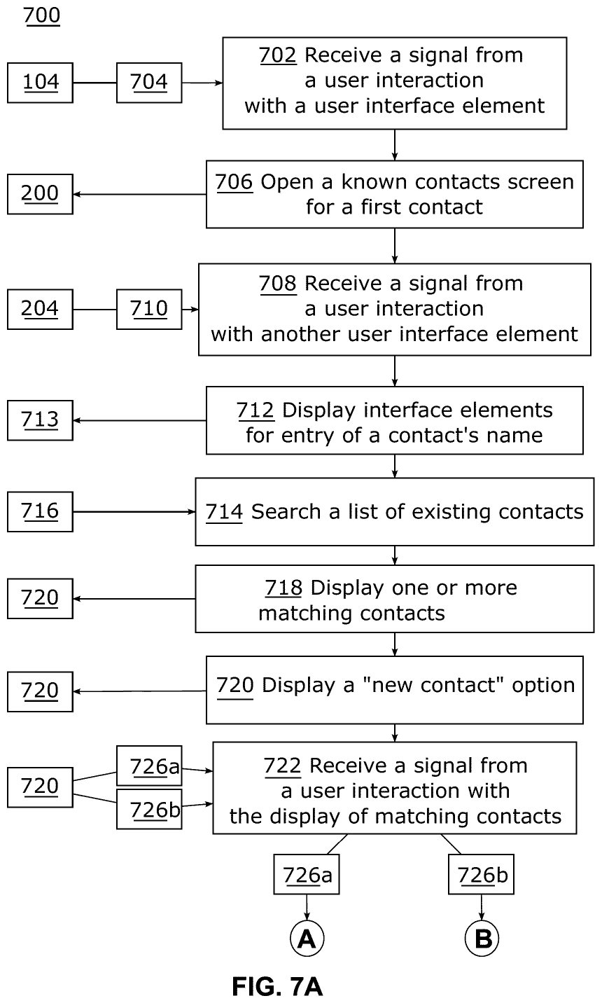

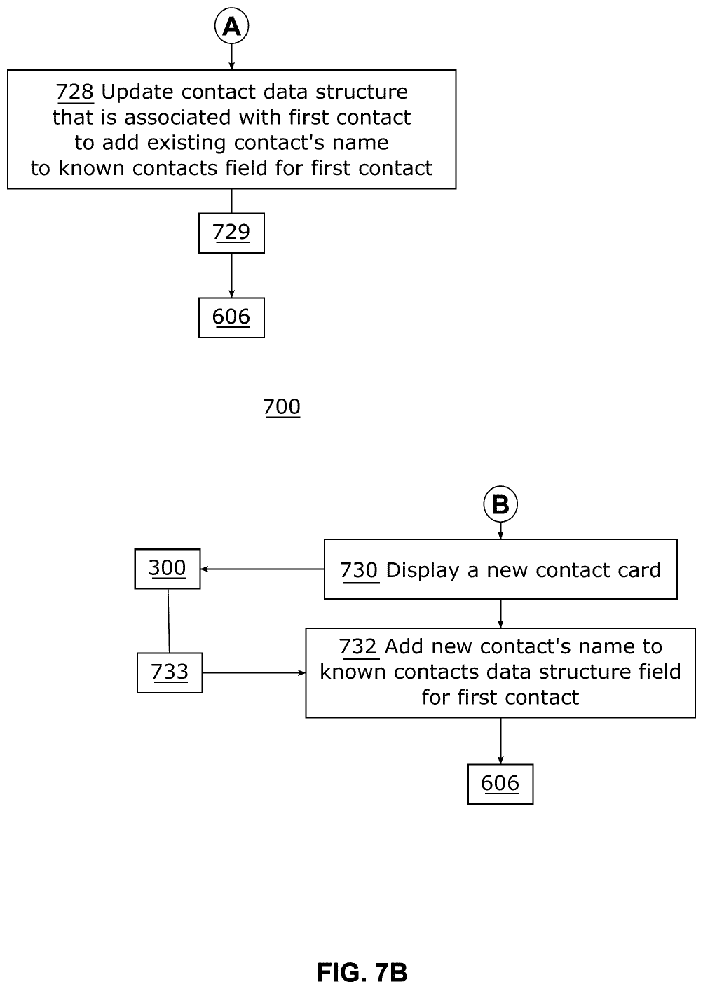

FIG. 7A and FIG. 7B depict a flow diagram of a method 700 for a computing device adding a new contact to the known contacts of an existing contact. The method includes a computing device responding to signals produced by user interactions with user interface elements. For example, in response to a user interaction, the computing device may add a new contact to an existing contact's new contacts, may update fields of a contact data structure, and/or may display a list of existing contacts to be added to a known contacts field of a contact data structure that is associated with a new contact or a known contact.

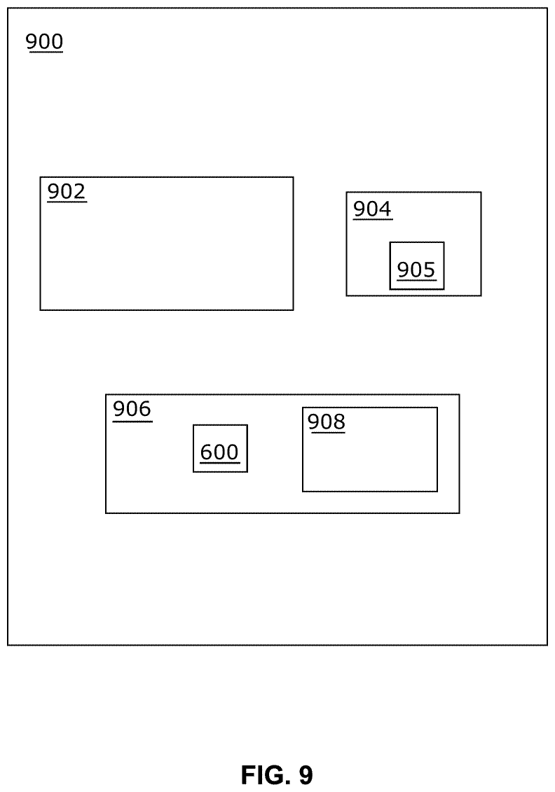

At 702, a computing device (such as the computing device 900 that is shown in FIG. 9) receives a signal 704 from a user interaction with a user interface element, such as, for example, a user actuating the control 104 that is discussed with reference to FIG. 1 and FIG. 3. At 706, in response to the signal 704, the computing device opens a known contacts screen for a first contact, such as the known contacts screen 200 that is discussed with reference to FIG. 2.

At 708, the computing device receives a signal 710 from a user interaction with another user interface element, such as, for example, a user actuating the control 204 that is discussed with reference to FIG. 2. At 712, in response to the signal 710, the computing device displays interface elements 713 (e.g., one or more text boxes) for entry of a contact's name.

In response to a user entering the first character of a contact's name, at 714 the computing device searches a list of existing contacts 716. At 718, the computing device displays one or more contacts that match the character(s) entered by the user. For example, the computing device may display matching contacts in a scrolling window or modal 720, in case a number of matching contacts exceeds a display capacity of the computing device. At 722, the computing device optionally may display a “new contact” option along with the matching contacts. The computing device may receive additional characters of the contact's name, re-search the list of existing contacts 716, and update the display 720 of matching contacts accordingly.

At 724, the computing device receives a signal 726a or 726b from a user interaction with the display of matching contacts. Depending on the signal 726a or 726b, the computing device either adds an existing contact to the first contact's known contacts or presents a new contact card for the user to fill in information (at least a name) and then adds the new contact to the first contact's known contacts.

For example, at 728, in response to the user selecting an existing contact from the display of matching contacts to generate the signal 726a, the computing device updates the contact data structure 602 that is associated with the first contact to add the existing contact's name 729 to the known contacts field 606.

On the other hand, at 730, in response to the user selecting “new contact” from the display of matching contacts to generate the signal 726b, the computing device displays a new contact card such as the contact card 300 that is discussed with reference to FIG. 3. At 732, in response to the user entering the new contact's name 733 (for example, in fields 302a and/or 302b of the contact card 300), the computing device adds the new contact's name 733 to the known contacts data structure field 606 that is associated with the first contact.

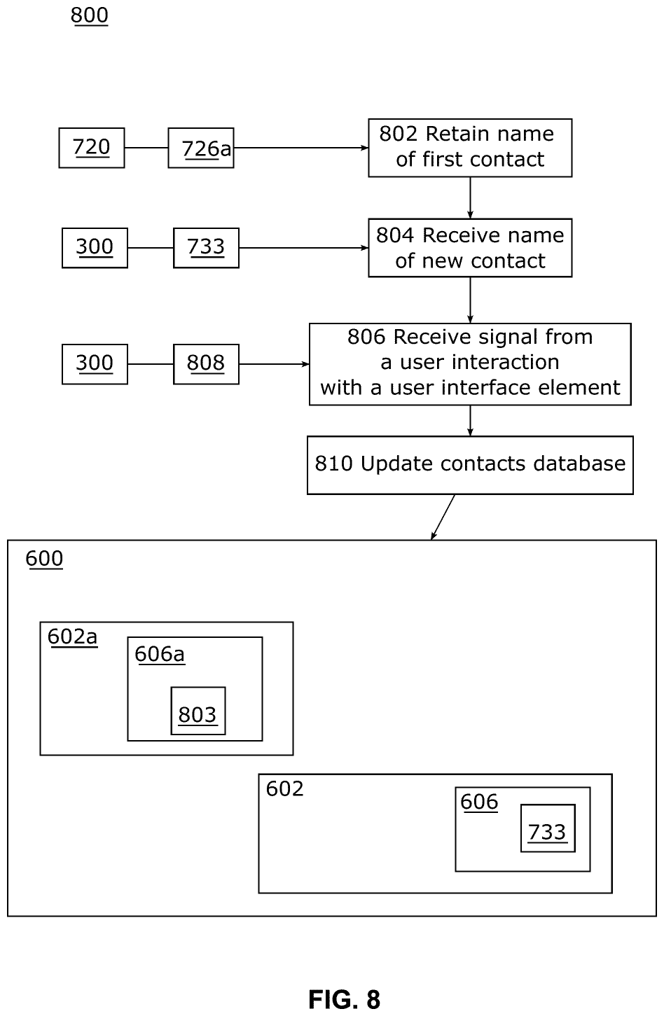

FIG. 8 depicts a flow diagram of a method 800 for a computing device adding an existing contact to the known contacts of a new contact. The method 800 begins when the computing device receives the signal 726b from a user interaction with the matching contacts display 720. At 802, the computing device retains the name 803 of the first contact. At 804, the computing device receives the new contact's name 733 (for example, by the user entering data in one or both of fields 302a and/or 302b of the new contact card 300). At 806, the computing device receives a signal 808 from a user interaction with a user interface element, for example, a user indicating in the new contact card 300 that they want to save the new contact. At 810, the computing device updates the contacts database 600. For example, the computing device adds a data structure 602a for the new contact and in the known contacts field 606a of the data structure 602a, the computing device adds the name 803 of the first contact. Meanwhile, in the known contacts field 606 of the data structure 602 for the first contact, the computing device adds the new contact's name 733.

It will be understood that, although the term “name” is used for simplicity of explanation, any unique identifier (e.g., a numeric or alphanumeric code in binary or hexadecimal format) may be entered into the known contacts fields 606a, 606 in place of the “names” 803, 805.

FIG. 9 depicts a computing device 900. The computing device 900 includes at least a processor 902, a display 904, an input device 905, and a non-transitory computer storage medium 906 that stores computer-executable instructions 908 for implementing the user interface of FIG. 1 through FIG. 5, the data structure 600 of FIG. 6, and the methods of FIG. 7 and FIG. 8. In operation of the computing device 900, the processor 902 reads the computer-executable instructions 908 from the medium 906 and is thereby configured to implement the user interface of FIG. 1 through FIG. 5, the data structure of FIG. 6, and the methods of FIG. 7 and FIG. 8. In one or more embodiments of the technology, the display 904 may incorporate the input device 905, for example, as a touchscreen or the like.

It will be appreciated that embodiments of the technology may be implemented in one or more computing devices, e.g., in a single stationary computer, in a networked server and client configuration, and/or in a mobile device such as a mobile phone. Computer executable instructions and data structures for implementing the technology may be stored in any non-transitory computer-readable medium that is associated with a computing device. The technology may be implemented by one or more processors of one or more computing devices. It will be appreciated that various displays and input devices are known to the ordinary skilled worker and that the present technology is not limited to any illustrative example of such displays or input devices.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computing device that is configured by computer-executable instructions to display a user interface comprising:
a first contact card that displays a first contact's name and a first control for accessing a known contacts screen for the first contact; and
the known contacts screen for the first contact, which displays at least (i) the name of a contact known by the first contact, and (ii) a second control for adding a new contact name;
wherein a second contact card for the contact known by the first contact is accessible from the known contacts screen by actuating the name of the contact known by the first contact.

2. The device of claim 1, wherein at least one of the controls is a button.

3. The device of claim 1, wherein the device is a mobile device.

4. The device of claim 1, wherein the first contact card also displays at least one mode of contacting the first contact.

5. A method for operating a computing device, the method comprising:
accessing a contact card in a user interface that is displayed by the computing device, wherein the contact card displays an existing contact's name and a first control; and
accessing, in the user interface, a known contacts screen that is associated with the contact by actuating the first control.

6. The method of claim 5, wherein the device is a mobile device.

7. The method of claim 5, further comprising:
accessing a new contact card by actuating a name of a contact on the known contacts screen that is associated with the contact; and
entering in the new contact card at least one mode of contacting the contact named on the new contact card.

8. The method of claim 5, wherein the first control is a button.

9. A method for operating a computing device, the method comprising:
receiving a first signal from a user interacting with a user interface element that is displayed by the computing device in a first contact card of a user interface;
opening a known contacts screen for a first contact in response to the first signal;
receiving a second signal from a user interaction with another user interface element that is displayed by the computing device in the known contacts screen;
displaying interface elements for entry of a contact's name;
searching a list of existing contacts in response to entry of one or more characters in the interface elements for entry of the contact's name;
displaying a display of one or more contacts that match the one or more characters;
receiving a signal from a user interaction with the display of matching contacts; and
adding a new contact's name to a known contacts data structure field for the first contact.
